(19) United States
(12) Patent Application Publication
(10) Pub. No.: US 2012/0287361 A1
(43) Pub. Date: Nov. 15, 2012

(54) STEREO IMAGE DISPLAY DEVICE

(75) Inventor: Toshinori Sugihara, Osaka-shi (JP)

(73) Assignee: Sharp Kabushiki Kaisha, Osaka (JP)

(21) Appl. No.: 13/508,625

(22) PCT Filed: Nov. 16, 2010
(86) PCT No.: PCT/JP2010/070366

§ 371 Date: May 8, 2012

(30) Foreign Application Priority Data
Nov. 18, 2009 (JP) 2009-262413

(51) Int. Cl. G02F 1/1335

(52) U.S. Cl. 349/15

(57) ABSTRACT

An object of the present invention is to provide a novel stereo image display device with lighter stereoscopic-viewing glasses and minimized flickering. A stereo image display device of the present invention includes: stereoscopic-viewing glasses including a first liquid crystal panel located in front of the left eye of a viewer for displaying a left eye image to be viewed by the left eye of the viewer, and a second liquid crystal panel located in front of the right eye of the viewer for displaying a right eye image to be viewed by the right eye of the viewer; and a white light source located in front of the viewer for emitting white light.

### TECHNICAL FIELD

The present invention relates to stereo image display devices.

### BACKGROUND ART

Several methods have been proposed for stereo image display devices that allow a viewer to see stereoscopic playback video.

JP5-183942A discloses a three-dimensional (3D), the entire body of which is in the form of a goggle, as shown in FIG. 6. The portion thereof that faces the left eye includes a display unit 202 for displaying left eye images. The portion thereof that faces the right eye includes a display unit 203 for displaying right eye images. Each display unit includes a backlight source composed of thin-film electroluminescent (EL) elements. The 3D display also includes earphones 204 for the left and right ears that generate stereo sound, the earphones extending from their respective temples 206 of the display. Such a 3D display, being in the form of a goggle, may be mounted on the face for use, allowing a large freedom in location and position of the viewer.

As shown in FIG. 7, JP2000-275575A discloses a stereo image display device including a monitor 305 that alternately displays a right eye image and a left eye image and a filter 302 between the monitor 305 and the right and left eyes of the viewer that operates in synchronization with monitor images. The viewer can view stereo images by viewing right eye images with his right eye and left eye images with his left eye. The filter 302 is composed of light scattering-type liquid crystal elements. When a right eye image is displayed on the monitor 305, the left eye portion scatters light and the right eye portion passes light to allow the right eye to view the monitor image. When a left eye image is displayed on the monitor, the right eye portion scatters light and the left eye portion passes light to allow the left eye to view the monitor image. This provides a stereo image display device that allows bright stereo images to be viewed with significantly improved transmittance of the liquid crystal elements.

As shown in FIG. 8, JP2005-92103A discloses a stereo image display device that includes a light-blocking barrier 402 spaced apart from a display panel 401 that is fixed in location, where each of the barrier elements of the light-blocking barrier 402 selectively blocks a right image or a left image on the display panel to display a 3D image. In this stereo image display device, at least one of the width and position of each of the barrier elements of the light-blocking barrier changes so as to cause an image to appear to be a 3D image to a viewer at or at around a viewing distance, which is the distance between the viewer and the display panel, as the viewing distance varies. This stereo image display device allows the viewer to view a stereo image without special glasses, and allows the optimum viewing distance in the front-to-back direction to be varied at a relatively low cost.

### DISCLOSURE OF THE INVENTION

However, each of these conventional stereo image display devices has its own problems, as described below.

In the 3D display described in JP5-183942A, each of the left and right eye display units includes a backlight source composed of thin-film EL elements. This increases the weight of the display, which makes it difficult to use it for a prolonged period of time.

Further, the stereo image display device described in JP2000-275575A includes liquid crystal glasses which do not include a backlight source and are thus lightweight, and allows the viewer to view an image on the monitor 305 by causing each portion of the filter 302 to alternately pass and scatter light. JP2000-275575A proposes active shutter liquid crystal glasses with transmission/scattering as a solution for changes in focal depth caused by darkness of viewed images in methods where each portion of the filter 302 alternately becomes transmissive and non-transmissive to light, a common problem with active shutter glasses. This solves the problem related to focal depth; however, since it utilizes scattering of light, the viewer alternately sees images and bright light from scattering. This may result in flickering of images on the screen. Moreover, if the environment is bright when the viewer views images, scattered light may exacerbate flickering. Furthermore, although typical transmissive/non-transmissive active shutter glasses mentioned as conventional art in JP2000-275575 cause almost no flickering of images on the screen, portions outside the display device may be perceived to flicker in a bright environment around the display device. As a result, the viewer may feel nauseous or dizzy or tired.

The stereo image display device described in JP2005-92103 allows the viewer to view a stereo image without special glasses; however, it is relatively expensive because of the addition of a light-blocking barrier 402, which requires mechanical precision, to the display panel 401. Further, one display panel must include pixels for displaying left eye images and pixels for displaying right eye images, requiring twice as many pixels. As a result, it is difficult to increase resolution.

An object of the present invention is to provide a novel stereo image display device with lighter stereoscopic-viewing glasses and minimized flickering.

A stereo image display device of the present invention includes: stereoscopic-viewing glasses including a first liquid crystal panel located in front of a left eye of a viewer for displaying a left eye image to be viewed by the left eye of the viewer, and a second liquid crystal panel located in front of a right eye of the viewer for displaying a right eye image to be viewed by the right eye of the viewer; and a white light source located in front of the viewer for emitting white light.

A stereo image display device of the present invention may realize lighter stereoscopic-viewing glasses while minimizing flickering.

### BRIEF DESCRIPTION OF THE DRAWINGS

FIG. 1 is a diagram of an entire exemplary stereo image display device according to Embodiment 1 of the present invention.

FIG. 2 is a perspective view of the stereo image display device according to Embodiment 1 of the present invention.

FIG. 3 is a configuration diagram of the stereo image display device according to Embodiment 1 of the present invention.

FIG. 4 is a configuration diagram of a stereo image display device according to Embodiment 2 of the present invention.

FIG. 5 illustrates slow axes and polarizing axes in Embodiment 2 of the present invention.

FIG. 6 illustrates a conventional goggle-type stereo image display device.

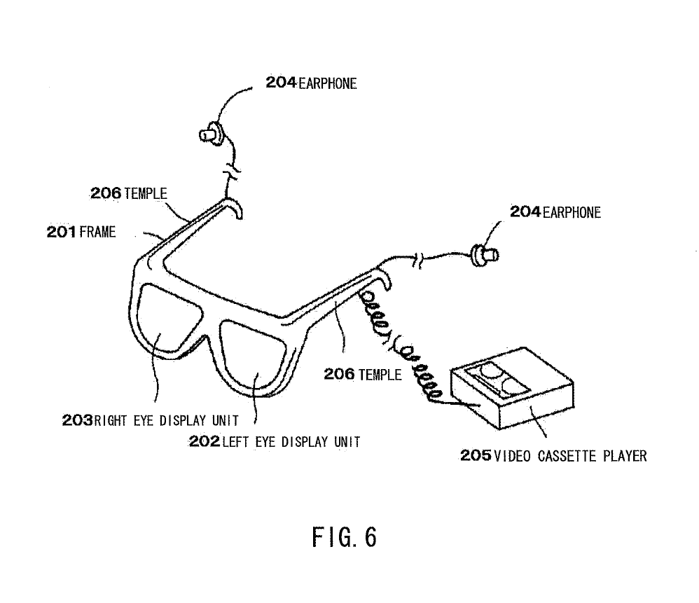

FIG. 7 illustrates a conventional liquid crystal shutter-type stereo image display device.

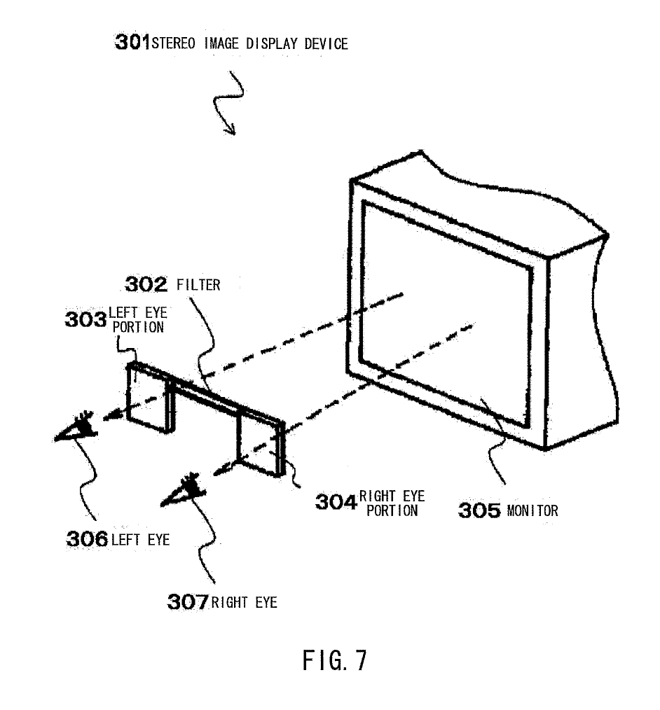

FIG. 8 illustrates a conventional parallax barrier-type stereo image display device.

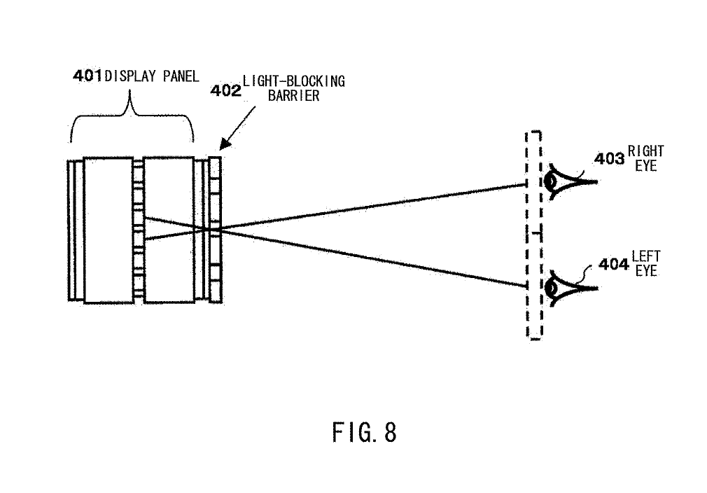

### EMBODIMENTS FOR CARRYING OUT THE INVENTION

A stereo image display device according to an embodiment of the present invention includes: stereoscopic-viewing glasses including a first liquid crystal panel located in front of a left eye of a viewer for displaying a left eye image to be viewed by the left eye of the viewer, and a second liquid crystal panel located in front of a right eye of the viewer for displaying a right eye image to be viewed by the right eye of the viewer; and a white light source located in front of the viewer for emitting white light (first arrangement).

In the first arrangement, a white light source is not provided on the stereoscopic-viewing glasses, resulting in lighter stereoscopic-viewing glasses.

Further, successive images may be displayed on each of the first and second liquid crystal panels. As a result, flickering may be minimized and high-quality stereo images may be presented to the viewer.

A second arrangement provides that, in the first arrangement, a first polarizer located closer to the viewer than the first liquid crystal panel is, a second polarizer located closer to the viewer than the second liquid crystal panel is, and a third polarizer located between the white light source and the stereoscopic-viewing glasses are further included. The third polarizer may be provided on the white light source, or may be provided on the stereoscopic-viewing glasses.

A third arrangement provides that, in the second arrangement, the first polarizer and the second polarizer are integrally formed.

A fourth arrangement provides that, in the second or third arrangement, the white light source is a display device with its display screen displaying white. In this arrangement, an existing display device may be employed. As a result, cost may be minimized.

A fifth arrangement provides that, in the fourth arrangement, a white display unit where the display screen of the display device displays white is further included.

A sixth arrangement provides that, in one of the first to fifth arrangements, a left eye image signal output module that outputs, to the first liquid crystal panel, a left eye image signal for displaying the left eye image on the first liquid crystal panel, and a right eye image signal output module that outputs, to the second liquid crystal panel, a right eye image signal for displaying the right eye image on the second liquid crystal panel are further included.

A seventh arrangement provides that, in one of the second to sixth arrangements, a first quarter wavelength plate located closer to the white light source than the first liquid crystal panel is, a second quarter wavelength plate located closer to the white light source than the second liquid crystal panel is, and a third quarter wavelength plate located closer to the viewer than the third polarizer is and located closer to the white light source than the first quarter wavelength plate and the second quarter wavelength plate are further included. This arrangement may prevent images displayed on the first and second liquid crystal panels from being darkened even when the viewer wearing the stereoscopic-viewing glasses tilts his head to the left or right.

An eight arrangement provides that, in one of the fourth to seventh arrangements, the display device includes the third polarizer. The display device including the third polarizer may be, for example, a liquid crystal display or plasma display, electroluminescent (EL) display, a field emission display (FED), or the like.

A ninth arrangement provides that, in the first arrangement, the first liquid crystal panel and the second liquid crystal panel have polymer-dispersed liquid crystal. This arrangement eliminates the need for a polarizer and an oriented film. This may minimize decrease in the amount of light passing through the first liquid crystal panel and the amount of light passing through the second liquid crystal panel. This may result in brighter images displayed on the first and second liquid crystal panels.

The present invention will now be described in detail by illustrating preferred embodiments. Of course, the present invention is not limited to the embodiments below. For ease of explanation, the drawings referred to in the description below schematically shows only those of the components of the embodiments of the present invention that are necessary to describe the present invention. As such, the present invention may include any components that are not shown in any of the drawings. The sizes of the components in the drawings do not exactly represent the sizes of the actual components or the size ratios of the components.

### Embodiment 1

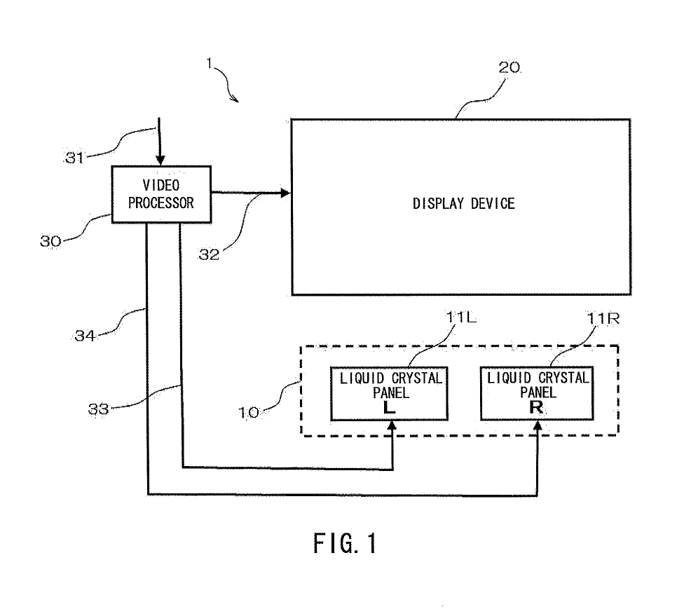

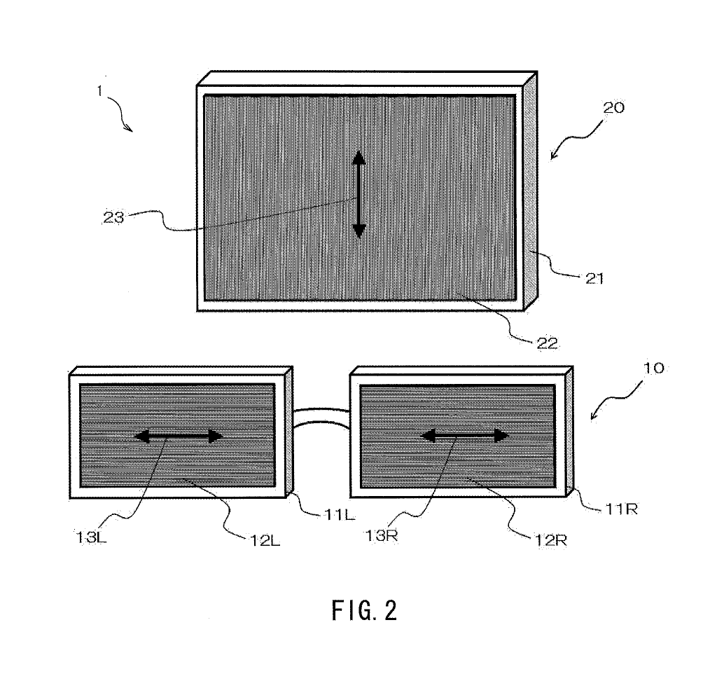

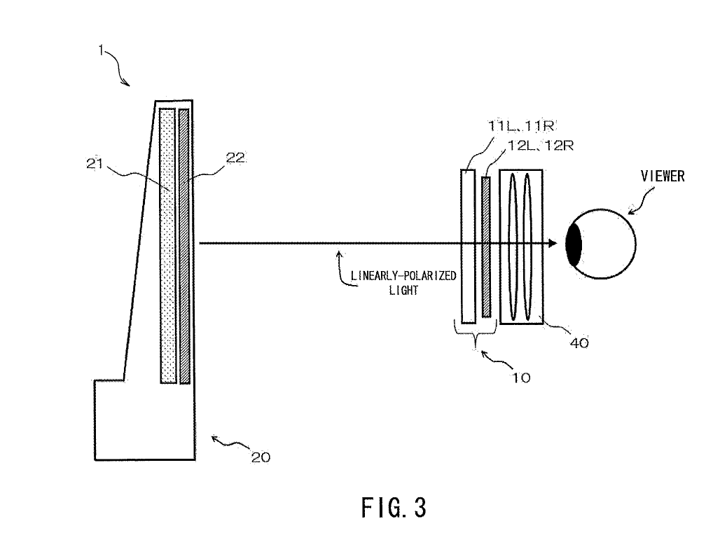

A stereo image display device 1 according to Embodiment 1 of the present invention will be described referring to FIGS. 1 to 3. FIG. 1 shows an entire exemplary stereo image display device 1 according to Embodiment 1 of the present invention. FIG. 2 is a perspective view of Embodiment 1 of the present invention. FIG. 3 is a configuration diagram of Embodiment 1 of the present invention.

As shown in FIG. 1, the stereo image display device 1 according to Embodiment 1 of the present invention includes three-dimensional (3D) glasses 10 that implement stereoscopic-viewing glasses, a display device 20 that implements a white light source, and a video processor 30 that processes video.

As shown in FIG. 2, the 3D glasses 10 are composed of a first liquid crystal panel 11L located at the left eye of the 3D glasses 10 and a second liquid crystal panel 11R located at the right eye of the glasses. Further, each of the liquid crystal panels 11L and 11R may be, for example, a liquid crystal panel of transmissive twist-nematic (TN) mode where a liquid crystal layer is provided between the thin-film transistor (TFT) substrate and the color filter substrate.

The liquid crystal layer included in each of the liquid crystal panels 11L and 11R may be polymer-dispersed liquid crystal. This eliminates the necessity for providing a polarizer or an oriented film. As a result, a sufficient amount of light passing through the liquid crystal panels 11L and 11R may be ensured to increase the brightness of images displayed on the liquid crystal panels 11L and 11R (left and right eye images) may be increased.

Further, a first polarizer 12L is located on the side of the first liquid crystal panel 11L that is closer to the viewer (i.e. the light emitting side), while a second polarizer 12R is located on the side of the second liquid crystal panel 11R that is closer to the viewer (i.e. the light emitting side). The first polarizer 12L and second polarizer 12R may be integrally formed.

As shown in FIGS. 2 and 3, the display device 20 may be, for example, a liquid crystal display composed of a liquid crystal panel 21 having a liquid crystal layer between the color filter (CF) substrate and the TFT substrate, a third polarizer 22 provided on the light emitting side of the liquid crystal panel 21 (i.e. display panel), a backlight unit, a speaker, and other components, not shown.

The orientation of the polarizing axes of the polarizers of the 3D glasses 10 and the display device 20 will now be described. As shown in FIG. 2, the first polarizer 12L and the second polarizer 12R of the 3D glasses 10 have polarizing axes (13L and 13R) that are in the horizontal direction, while the third polarizer 22 of the display device 20 has a polarizing axis 23 that is in the vertical direction such that the 3D glasses 10 and the display device 20 have polarizing axes perpendicular to each other.

The video processor 30 receives a stereo image signal 31 from, for example, a 3D broadcast or 3D VTR or a game machine, and causes the display screen of the display device 20 to display white and outputs a left eye image signal 33 and a right eye image signal 34 to the 3D glasses 10. As can be understood, in the present embodiment, the white display unit, the left eye image signal output module and the right eye image signal output module are implemented by the video processor 30.

In the above configuration, when a stereo image is to be viewed, a white display image signal 32 output from the video processor 30 causes the entire display screen of the display device 20 to display white. At the 3D glasses 10, a left eye image signal 33 output from the video processor 30 drives the first liquid crystal panel 11L and a right eye image signal 34 output from the video processor 30 drives the second liquid crystal panel 11R. As such, the viewer may wear the 3D glasses 10 and turn his face toward the display device 20 to view a stereo image through the 3D glasses 10, where white light emitted from the display device 20 serves as a light source.

Specifically, as shown in FIG. 3, light emitted from the display device 20 is white light produced by combining light of three primary colors (R, G and B), where light emitted from the backlight unit (not shown) included in the display device 20 passes through the liquid crystal layer and the color filter of the liquid crystal panel 21 and passes through the third polarizer 22 to be linearly polarized.

Linearly polarized white light enters the 3D glasses 10. At the left eye of the 3D glasses 10, the rotation of the polarizing axis is controlled by the first liquid crystal panel 11L in response to an image signal; then, light passes through the first polarizer 12L to be adjusted to the amount of light corresponding to the image signal 33, passes through an optical unit 40 composed of a group of lenses such as a convex lens, concave lens, Fresnel lens and diffractive lens to be enlarged or focused, and is successively displayed as left eye images. At the right eye of the 3D glasses 10, light passes similarly through the second liquid crystal panel 11R, second polarizer 12R and optical unit 40 to be successively displayed as right eye images.

The viewer, wearing the 3D glasses 10, views successively displayed left eye images with his left eye, and views successively displayed right eye images with his right eye to perceive the left and right images as stereo images. Sound can be heard via the speaker on the display device 20. Accordingly, no audio output unit such as an earphone or a speaker is necessary on the 3D glasses 10.

Although the display device 20 has been described as a liquid crystal display, other displays such as a plasma display, EL display, field emission display (FED) including a third polarizer 22 on the light emitting side of the display panel and capable of emitting linearly-polarized white light may be used as a display device 20.

A display that does not include a third polarizer 22, such as a CRT, may be used as a display device 20 if a third polarizer 22 is added on its front side, i.e. the light emitting side. Similarly, a plasma display, EL display, FED or the like that does not include a third polarizer 22 may be used as a display device 20 if a third polarizer 22 is added on their light emitting side. A third polarizer 22 may be located anywhere between the display device 20 and the 3D glasses 10. For example, a third polarizer 22 may be provided on the 3D glasses 10.

In the stereo image display device 1 of Embodiment 1, an existing liquid crystal display or the like may be used as a display device 20 and can serve as a light source for the 3D glasses 10 (i.e. a backlight). Thus, low cost 3D glasses 10 without a backlight may be provided. As a result, the cost for displaying stereo images may be minimized to allow stereo images to be viewed without much trouble. Further, stereo images may be viewed simultaneously by a plurality of viewers wearing 3D glasses 10.

Furthermore, since the display device 20 is capable of displaying normal images, and the three primary colors (R, G and B) are optimally adjusted in coloration, the display device is capable of producing by combination and emitting white light optimized to work as a light source (backlight) for the first liquid crystal panel 11L and second liquid crystal panel 11R included in the 3D glasses 10.

In addition, sound may be heard via a speaker on the display device 20. Thus, an audio output unit such as an earphone or speaker is not necessary on the 3D glasses 10. As a result, the arrangement of the 3D glasses 10 may be simplified and made lighter, thereby reducing discomfort and tiredness that the viewer feels when he uses the glasses for a prolonged period of time.

Further, the first liquid crystal panel 11L of the 3D glasses 10 is driven by a left eye image signal 33 while the second liquid crystal panel 11R is driven by a right eye image signal 34. Thus, left eye images are displayed successively on the left eye of the 3D glasses 10 while right eye images are displayed successively on the right eye of the glasses. As a result, high-quality stereo images without flickering may be viewed.

### Embodiment 2

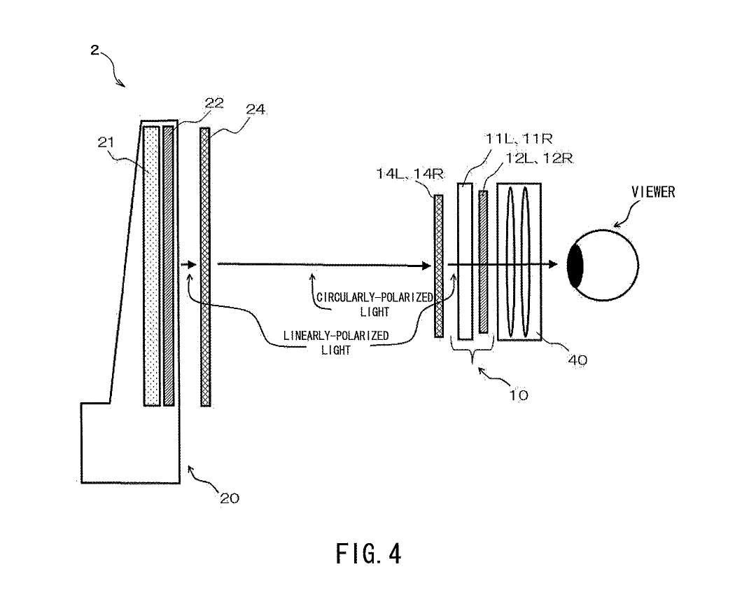

As shown in FIG. 4, a stereo image display device 2 according to Embodiment 2 of the present invention may be constructed by adding a first quarter wavelength plate 14L, a second quarter wavelength plate 14R and a third quarter wavelength plate 24 between the 3D glasses 10 and the display device 20 of Embodiment 1; the rest of the system is the same as in Embodiment 1, and its description will be omitted.

In Embodiment 1, supposing that the liquid crystal's mode is TN mode, bright images can be viewed without a loss of light when the polarizing axis of the first polarizer 12L and the second polarizer 12R of the 3D glasses 10 is perpendicular to that of the third polarizer 22 of the display device 20, as shown in FIG. 2.

However, if, for example, a viewer wearing 3D glasses 10 tilts his head to the left or right relative to the display device 20 such that the first polarizing axis 13L and second polarizing axis 13R of the 3D glasses 10 are displaced from the perpendicular direction relative to the third polarizing axis 23 of the display device 20, left and right images displayed on the 3D glasses 10 become darker, resulting in deterioration in visibility.

Specifically, when light with the rotation of its polarizing axis controlled by the first liquid crystal panel 11L passes through the first polarizer 12L, there exists a loss in passing light corresponding to the amount of displacement of the polarizing axis. This results in reduced amount of light emitted from the first polarizer 12L. As a result, images displayed on the left eye of the 3D glasses 10 become darker. Similarly, the amount of light emitted from the second polarizer 12R decreases, resulting in darkened images displayed on the right eye of the glasses. Embodiment 2 provides a stereo image display device that mitigates such deterioration of display quality caused by a displacement from the perpendicular relationship between the polarizing axes of the third polarizer 22 of the display device 20 and the first polarizer 12L and second polarizer 12R of the 3D glasses 10.

As shown in FIG. 4, in the stereo image display device 2 of Embodiment 2, a third quarter wavelength plate 24 is located on the outer side (light emitting side) of the third polarizer 22 of the display device 20, while a first quarter wavelength plate 14L is located on the outer side (light entering side) of the first liquid crystal panel 11L of the 3D glasses 10 and, similarly, a second quarter wavelength plate 14R is located on the outer side (light entering side) of the second liquid crystal panel 11R.

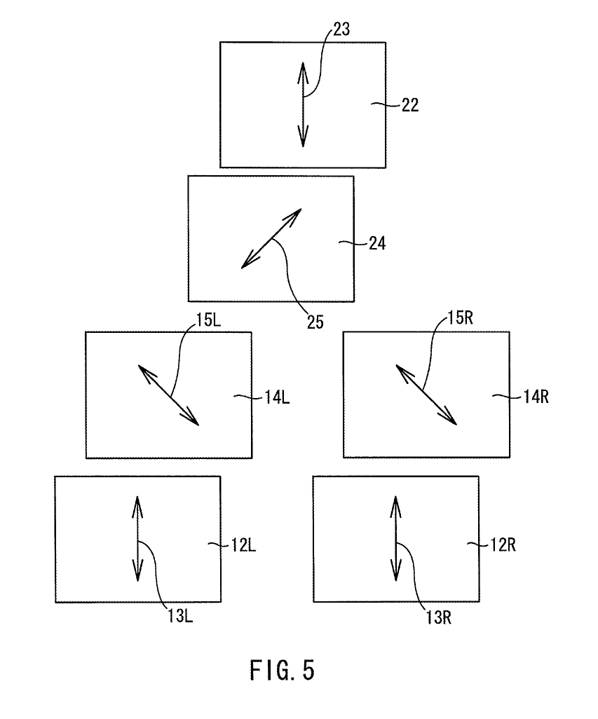

The slow axis of the first quarter wavelength plate 14L is angled at 45 degrees relative to the polarizing axis of the first polarizer 12L; the slow axis of the second quarter wavelength plate 14R is similarly angled relative to the polarizing axis of the second polarizer 12R; and the slow axis of the third quarter wavelength plate 24 is also angled at 45 degrees relative to the polarizing axis of the third polarizer 22. Specifically, for example, as shown in FIG. 5, if the slow axis 25 of the third quarter wavelength plate 24 is angled at 45 degrees clockwise (turned to the right) relative to the polarizing axis 23 of the third polarizer 22 that extends in the vertical direction on the display screen, the slow axis 15L of the first quarter wavelength plate 14L is angled at 45 degrees counter-clockwise (turned to the left) relative to the polarizing axis 13L of the first polarizer 12L and the slow axis 15R of the second quarter wavelength plate 14R is angled at 45 degrees counter-clockwise (turned to the left) relative to the polarizing axis 13R of the second polarizer 12R. In other words, the slow axis 15L of the first quarter wavelength plate 14L and the slow axis 15R of the second quarter wavelength plate 14R are perpendicular to the slow axis 25 of the third quarter wavelength plate 24.

In FIG. 4, at the display device 20, the liquid crystal panel 21 combines light emitted from a light source, not shown, to produce white light, which passes through the third polarizer 22 to become linearly-polarized light that passes through the third quarter wavelength plate 24 to be converted into circularly-polarized light before being emitted.

When circularly-polarized white light enters the 3D glasses 10, for the left eye of the 3D glasses 10 the light passes through the first quarter wavelength plate 14L to be reconverted into linearly-polarized light. Since the slow axis 15L of the first quarter wavelength plate 14L is slanted i.e. perpendicular to the slow axis 25 of the third quarter wavelength plate 24, the polarizing axis of white light that has been linearly polarized by the first quarter wavelength plate 14L is now in the vertical direction. Similarly, since the slow axis 15R of the second quarter wavelength plate 14R is slanted i.e. perpendicular to the slow axis 25 of the third quarter wavelength plate 24, the direction of the polarizing axis of white light that has been linearly polarized by the second quarter wavelength plate 14R is now in the vertical direction.

Then, similar to Embodiment 1, the rotation of the polarizing axis is controlled by the first liquid crystal panel 11L and passes through the first polarizing axis 12L to be adjusted to the amount of passing light corresponding to an image signal 33, and passes through an optical unit 40 composed of a lens group of a convex lens, concave lens, Fresnel lens, diffractive lens or the like to be enlarged or focused before being displayed successively as left eye images. Similarly, the rotation of the polarizing axis is controlled by the second liquid crystal panel 11R and passes through the second polarizing axis 12R to be adjusted to the amount of passing light corresponding to an image signal 34, and passes through another optical unit 40 composed of a lens group to be enlarged or focused before being displayed successively as right eye images.

The viewer wearing the 3D glasses 10 views successively displayed left eye images with his left eye and views successively displayed right eye images with his right eye to view high-quality stereo images without flickering.

In the stereo image display device 2 of Embodiment 2, white light between the display device 20 and the 3D glasses 10 is circularly polarized such that images displayed on the 3D glasses 10 do not become darkened even when the viewer wearing the 3D glasses 10 tilts his head to the left or right relative to the display device 20, i.e. does not properly face the display device 20; even a plurality of viewers wearing 3D glasses can view stereo images simultaneously, where the position of each viewer relative to the display device 20 while viewing images is not restricted.

Although Embodiments 1 and 2 have been specifically illustrated, the present invention is not limited thereto. Implementations that can be obtained by combining technical means disclosed in the above Embodiments are within the technical scope of the present invention.

For example, the video processor 30 may be incorporated into the 3D glasses 10 or the display device 20. The video processor 30 may receive a normal 2D image signal and internally perform video processing to generate left and right image signals.

The display device 20 may cause its display screen to display white in response to an output signal from the video processor 30, as in Embodiments 1 and 2, or may cause its display screen to display white in response to an operation of a switch on the display device 20 itself or on a remote control.

In the Embodiments, the liquid crystal's mode of the first liquid crystal panel 11L and second liquid crystal panel 11R of the 3D glasses 10 is TN mode in a normally-white arrangement where, as shown in FIG. 3, the polarizing axis of the 3D glasses 10 (implemented by the polarizing axis 13L of the first polarizer 12L and the polarizing axis 13R of the second polarizer 12R) is perpendicular to the polarizing axis of the display device 20 (implemented by the polarizing axis 23 of the third polarizer 22); however, a normally-black arrangement may be used where the polarizing axis of the 3D glasses 10 is parallel to the polarizing axis of the display device 20.

Further, the liquid crystal's mode of the 3D glasses 10 is not limited to TN mode, and other modes such as STN, MVA, PVA, IPS, FFS, OCB, PSA, photo-alignment liquid crystal, perpendicularly-oriented in-plane electric field switching liquid crystal may be used. The positional relationships between the polarizing axes of the first to third polarizers or the positional relationships between the slow axes of the first to third quarter wavelength plates may be modified depending on the liquid crystal's mode.

1. A stereo image display device comprising:
stereoscopic-viewing glasses including
a first liquid crystal panel located in front of a left eye of a viewer for displaying a left eye image to be viewed by the left eye of the viewer, and
a second liquid crystal panel located in front of a right eye of the viewer for displaying a right eye image to be viewed by the right eye of the viewer; and
a white light source located in front of the viewer for emitting white light.

2. The stereo image display device according to claim 1, further comprising:
a first polarizer located closer to the viewer than the first liquid crystal panel is;
a second polarizer located closer to the viewer than the second liquid crystal panel is; and
a third polarizer located between the white light source and the stereoscopic-viewing glasses.

3. The stereo image display device according to claim 2, wherein the first polarizer and the second polarizer are integrally formed.

4. The stereo image display device according to claim 2, wherein the white light source is a display device with its display screen displaying white.

5. The stereo image display device according to claim 4, further comprising a white display unit where the display screen of the display device displays white.

6. The stereo image display device according to claim 1, further comprising:
a left eye image signal output module that outputs, to the first liquid crystal panel, a left eye image signal for displaying the left eye image on the first liquid crystal panel; and
a right eye image signal output module that outputs, to the second liquid crystal panel, a right eye image signal for displaying the right eye image on the second liquid crystal panel.

7. The stereo image display device according to claim 2, further comprising:
a first quarter wavelength plate located closer to the white light source than the first liquid crystal panel is;
a second quarter wavelength plate located closer to the white light source than the second liquid crystal panel is; and
a third quarter wavelength plate located closer to the viewer than the third polarizer is and located closer to the white light source than the first quarter wavelength plate and the second quarter wavelength plate.

8. The stereo image display device according to claim 4, wherein the display device includes the third polarizer.

9. The stereo image display device according to claim 1, wherein the first liquid crystal panel and the second liquid crystal panel have polymer-dispersed liquid crystal.
